(19) United States
(12) Patent Application Publication
(10) Pub. No.: US 2025/0299175 A1
(43) Pub. Date: Sep. 25, 2025

(54) METHOD AND APPARATUS FOR DEFINING A DISTRIBUTED PAYMENT SYSTEM

(71) Applicant: Affirm, Inc., San Francisco, CA (US)

(72) Inventors: Srivathsava Rangarajan, San Francisco, CA (US); Laurence Duggan, San Francisco, CA (US); Tommy Tai, San Francisco, CA (US)

(21) Appl. No.: 18/615,278

(22) Filed: Mar. 25, 2024

(51) Int. Cl. G06Q 20/22; G06Q 20/02

(52) U.S. Cl. CPC G06Q 20/227; G06Q 20/023

(57) ABSTRACT

A distributed payment system may include a first bank at which a user deposit account of a customer is established where the user deposit account is associated with a vehicle of the customer to fund transactions initiated via the payment vehicle, a second bank at which a facilitator account of a card issuer of the payment vehicle is established, and a facilitation agent in communication with a first bank agent of the first bank and a second bank agent of the second bank to issue messages or system triggers associated with money transfers within the distributed payment system. The facilitation agent establishes a facilitator clearing account to hold unreconciled funds of customers having payment vehicles and deposit accounts at the first bank, and establishes a facilitator servicing account to hold reconciled funds of the customers having payment vehicle and deposit accounts at the first bank. The facilitation agent facilitates real time transfer of money into and out of the user deposit account with respect to the facilitator clearing account responsive to the customer initiating a transaction, facilitates a net transfer of money between the facilitator clearing account and the facilitator servicing account based on summing all transactions in a given period, and facilitates a transfer of funds between the facilitator servicing account and the facilitator account of the second bank based on the summing of all transactions in the given period.

### TECHNICAL FIELD

Example embodiments generally relate to financial industry technologies and, in particular, relate to apparatuses, systems, and methods for facilitating real-time money movement among different banks when making/receiving a payment where the deposit account is different from the account and/or instrument used as the payment vehicle.

### BACKGROUND

The financial industry is comprised of many thousands of customers, merchants, lenders, borrowers, and other role players that all interact in various ways to enable customers to ultimately have access to goods and services provided by merchants. Credit and debit transactions have long been a way that individuals have managed point of sale transactions to ensure seamless transfer of funds from customers, or on their behalf, to merchants for relatively routine or small transactions. Meanwhile, obtaining a loan from a bank has long been the most common way of obtaining financing for non-routine or larger transactions. More recently, installment loan financing has become a popular option.

Credit cards and certain other lending vehicles may be useful tools for many customers. However, some customers can find themselves over extended either quickly or over a period of time based on the existing tools. This phenomenon has repeated itself over generations, and for millions of customers. Thus, there is now a deep desire on the part of many to create flexible and fair means of supporting customer purchasing activities that is both honest and transparent, and that also improves the lives of customers.

Installment loans, or buy now, pay later financing, have become a popular tool in relation to addressing the issues noted above. However, even this popular tool typically gets employed at the time a purchase is being undertaken. For example, the customer may select a product of interest and proceed to checkout (virtually or at a brick and mortar store) to purchase the product. The payment means selected to pay the merchant for the product may be a physical or virtual card that is linked to accounts that enable an installment loan to be granted to the customer, and funds may be transferred to the merchant on behalf of the customer for purchase of the product, if the customer is approved for the installment loan.

In other cases, such as when a payment card (e.g., a credit or debit card) is presented by a customer for payment at checkout, the decision making progress regarding whether to support the transaction must be made very quickly, and the algorithms and policies that are involved may include account balances or checks that cannot necessarily be instantaneously done, or appreciated to be fully accurate since other transactions, or even a series of transactions, may have been made since the latest information available for review can be obtained. These situations may create risk for the issuer of the payment card, and may also result in undesirable negative impacts on the customer.

One example of a situation in which a user (i.e., a customer and potential borrower) may suffer in relation to delays that are inherent in the system may arise in the context of transactions involving enabling Automated Clearing House (ACH) transfers or payments. ACH payments are a form of electronic bank transaction made using a network (i.e., the ACH network) that is formed from a system of computers that communicate with each other to make and receive payments. For each transaction there is one computer at the sending end to send a request for payment, and another computer at the receiving end to accept the request. Whereas many customers may imagine that a financial transaction somehow transfers money directly from their accounts into the corresponding accounts of merchants that is typically not the case. Instead, the card issuer or related entity (as described in more detail below) may transfer money from an account on behalf of the customer to the vendor to support the transaction, and then the card issuer may request an ACH transfer from the customer account to cover the transaction.

Although fairly standard as a method of transferring money, the movement of the money associated with various different types of reimbursement (e.g., ACH and others) can be relatively slow. In this regard, for example, a lender or bank or related finance company may submit a file containing all of the transfers that are to be performed to initiate the process, but there is generally no confirmation received through the system to indicate whether or not each transaction has gone through successfully. The only communication received from the system is generally received in the event of a failure for either insufficient funds or an account being closed, for example. Moreover, even notifications of failed ACH transfers may take 1 to 2 business days to be received.

The fact that there is no confirmation for successful transfers can create a problem for a card user (and consequently for a card issuer) since it is not clear what the current status of the user (or customer) account(s) may be at the time a transaction needs to be made. The card issuer must therefore balance the risk of floating money to a customer against the uncertainty of the accuracy of account information. Should the card issuer decide to take the risk in a situation where the customer has had intervening transactions taking money from his/her account that causes an ACH transfer to fail, both the customer and the card issuer may receive financial penalties in the form of failed transfer fees.

As can likely be appreciated from the description above, it would be preferable to avoid the inherent delays associated with the ACH system. However, doing so would require a differently structured system that permits real-time money transfers among different banks, particularly where a payment card and corresponding deposit account are different from the card issuer's account. In other words, in situations in which the customer has an account at the card issuing bank and the bank supporting the deposit account. Accordingly, some example embodiments may enable the provision of technical means by which to provide a real-time way to move money that avoids the disadvantages of the current ACH system.

### BRIEF SUMMARY OF SOME EXAMPLES

Accordingly, some example embodiments may enable the provision of technical means by which to accurately reflect an account balance for a payment vehicle such as a payment card of a user that has the account supporting the payment vehicle's activity at a different bank than the bank used by the card issuer. Such ability may enable credit extension decisions or other decisions that may otherwise be risky if the information they are based upon is inaccurate to be made with confidence thereby improving satisfaction and efficiency for the entire system.

In an example embodiment, a distributed payment system is provided. The system may include a first bank at which a user deposit account of a customer is established where the user deposit account is associated with a payment vehicle of the customer to fund transactions initiated via the payment vehicle, a second bank at which a facilitator account of a card issuer of the payment vehicle is established, and a facilitation agent in communication with a first bank agent of the first bank and a second bank agent of the second bank to issue messages or system triggers associated with money transfers within the distributed payment system. The facilitation agent establishes a facilitator clearing account to hold unreconciled funds of customers having payment vehicles and deposit accounts at the first bank, and establishes a facilitator servicing account to hold reconciled funds of the customers having payment vehicles and deposit accounts at the first bank. The facilitation agent facilitates real time transfer of money into and out of the user deposit account with respect to the facilitator clearing account responsive to the customer initiating a transaction, facilitates a net transfer of money between the facilitator clearing account and the facilitator servicing account based on summing all transactions in a given period, and facilitates a transfer of funds between the facilitator servicing account and the facilitator account of the second bank based on the summing of all transactions in the given period.

In another example embodiment, a method for instantaneous transaction with respect to a user deposit account at a different bank than a card issuer account for a payment vehicle used for transacting may be provided. The method may include establishing communication with a first bank agent of a first bank and a second bank agent of a second bank to issue messages or system triggers associated with money transfers within a distributed payment system, where the first bank has the user deposit account of a customer established. The method may further include establishing a facilitator clearing account to hold unreconciled funds of customers having payment vehicles and deposit accounts at the first bank, establishing a facilitator servicing account to hold reconciled funds of the customers having payment vehicles and deposit accounts at the first bank, and facilitating real time transfer of money into and out of the user deposit account with respect to the facilitator clearing account responsive to the customer initiating a transaction. The method may also include facilitating a net transfer of money between the facilitator clearing account and the facilitator servicing account based on summing all transactions in a given period, and facilitating a transfer of funds between the facilitator servicing account and a facilitator account of the card issuer at a second bank based on the summing of all transactions in the given period.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for providing a selective financing and payment platform according to an example embodiment;

FIG. 2 illustrates a functional block diagram of an apparatus for defining a facilitation agent according to an example embodiment;

FIG. 3 illustrates a block diagram showing a distributed payment system in accordance with an example embodiment;

FIG. 4 illustrates a block diagram for demonstrating a flow of funds in the distributed payment system for authorization and capture in accordance with an example embodiment;

FIG. 5 illustrates a block diagram for demonstrating a flow of funds in the distributed payment system for a refund in accordance with an example embodiment;

FIG. 6 illustrates a block diagram for demonstrating a flow of funds in the distributed payment system for a perfect capture in accordance with an example embodiment;

FIG. 7 illustrates a block diagram for demonstrating a flow of funds in the distributed payment system for a refund involving a loan repayment in accordance with an example embodiment;

FIG. 8 illustrates a block diagram for demonstrating a flow of funds in the distributed payment system for a loan repayment in accordance with an example embodiment; and

FIG. 9 illustrates a block diagram of a method for instantaneous transaction with respect to a user deposit account at a different bank than a card issuer account for a payment card used for transacting in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide for a data processing platform that can be instantiated at an apparatus comprising configurable processing circuitry. The processing circuitry may be configured to execute various processing functions on financial data using the techniques described herein. The data processing platform may, for example, be configured to provide an information exchange via which multiple independent or even proprietary platforms may be connected to each other. As such, the data processing platform may be embodied as a selective financing and payment platform (i.e., SFP platform) that connects customers and merchants (or vendors) to banks, payment services, and a transaction facilitator within the financial industry. By enabling data between the players on or members of the platform to be shared, and by further providing customers with tools for using the platform to manage (or plan) financing of individual transactions even before the transactions occur, customers may have increased flexibility for managing their funds in a way that prevents over-extension, while still maximizing their access to the goods and services they desire or need at any given time. Moreover, the platform may be employed under the management of the facilitator to control the usage of data on mutually agreeable terms for all participants who access the platform. Accordingly, a commercial framework can be provided by a technical platform designed to connect customers with access to financial support to effect transactions in real time.

However, example embodiments further enable transfers of money to be instantaneous in a context that normally requires the unavoidable delays of the ACH transfer system, or other means of money transfer to reimburse the card issuer account that involve multi-second delay processes that can have timing issues that put system operational integrity at risk. Moreover, example embodiments enable what is effectively instantaneous transfer of money both for the conduct of a transaction and also in relation to product return and refund activities. In other words, instead of merely initiating a platform for supporting installment loan (or other financing options) decisions before or at the time of the transactions, example embodiments provide a technical means by which to obtain financing for a particular transaction, where the monetary transfers supporting the transaction can be conducted in real-time both for the transaction itself, and also in relation to the handling of any product return activity be associated with the transaction so that the refund can be handled with respect to the particular transaction when the transaction is supported by a payment card or otherwise involves a payment where the deposit account is different from the account and/or instrument used as the payment vehicle.

In this regard, the normal situation when the deposit account is at one bank and the card account is at another bank is that the transaction is supported behind the scenes via ACH transactions that take on the order of days to actually occur, or even other money transfer means that take shorter periods of time. Example embodiments that employ the SFP platform define a distributed payment system that facilitates real-time money movement among different banks when transacting with a payment vehicle, which could include any means for sending/receiving payments including, for example, a payment card (e.g., a debit card), where the payment card account is different from the card issuer account (i.e., the customer has an account at the card issuing bank and the bank supporting the deposit account, which are different banks). Example embodiments of the SFP platform may overcome the disadvantages of a typical ACH system by enabling authorization (or holding) of funds, real-time balance checks, and real time fund movement (e.g., settlement). As such, the SFP platform may support several use cases including, for example, debit (pay now) purchases where authorization/capture happen at the same time (e.g., the system enables funding of the issuing account while simultaneously pulling funds from a deposit account), loan repayment, and returns. This stands in contrast to today's paradigm in which a fund transfers for transactions and returns play out over a period of days. The creation of one platform, managed by the facilitator, for the interaction of multiple parties to enable a determination of whether funds can be transferred in real-time to support transactions, loan payments, and returns provides a flexible and yet cohesive experience for customers that maximizes responsible access to financial freedom and satisfaction.

Example embodiments not only provide the SFP platform, but also provide various enabling technologies that may facilitate operation of the SFP platform itself or of modules that may interact with the SFP platform. Example embodiments may also provide for enhancement of functionalities associated with the environment that is created by the SFP platform. The SFP platform may provide a mechanism by which to enhance commerce in a responsible way that is both empathetic and empowering to customers.

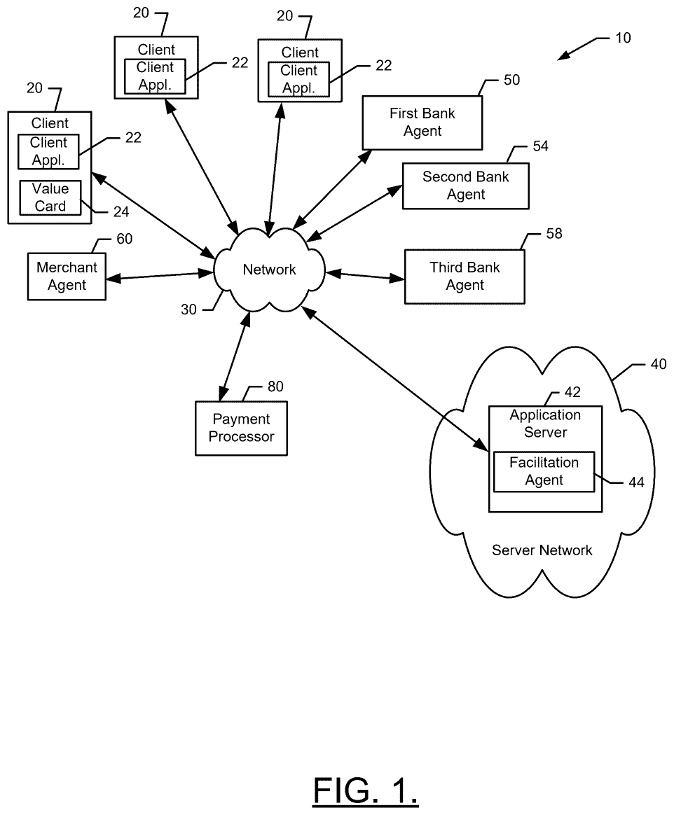

An example embodiment will now be described in reference to FIG. 1, which illustrates an example system in which an example embodiment may be employed. As shown in FIG. 1, a system comprising an SFP platform 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system. Furthermore, in some cases, some embodiments may be practiced on a single client without any connection to the system.

The clients 20 may, in some cases, each be associated with a single individual or customer. However, in some embodiments, one or more of the clients 20 may be associated with an organization (e.g., a company) or group of individuals (e.g., a family unit). In general, the clients 20 may be referred to as members of the environment or community associated with the SFP platform 10.

Each one of the clients 20 may include one or more instances of a communication device such as, for example, a computing device (e.g., a computer, a server, a network access terminal, a personal digital assistant (PDA), radio equipment, cellular phone, smart phone, tablet, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms, and corresponding communication protocols.

In an example embodiment, devices to which the clients 20 may be coupled via the network 30 may include one or more application servers (e.g., application server 42), and/or a database server, which together may form respective elements of a server network 40. Although the application server 42 and the database server are each referred to as “servers,” this does not necessarily imply that they are embodied on separate servers or devices. As such, for example, a single server or device may include both entities and the database server could merely be represented by a database or group of databases physically located on the same server or device as the application server 42. The application server 42 and the database server may each include hardware and/or software for configuring the application server 42 and the database server, respectively, to perform various functions. As such, for example, the application server 42 may include processing circuitry or logic and memory enabling the application server 42 to access and/or execute stored computer readable instructions for performing various functions. In an example embodiment, one function that may be provided by the application server 42 may be the provision of access to information and/or services related to the SFP platform 10, and more particularly relating to facilitating transactions where the details of setting the transaction will be determined after the transaction. For example, the application server 42 may be configured to provide for storage of information descriptive of events or activities associated with the SFP platform 10 and the execution of a financial transaction on behalf of a customer in real-time, while money transfers for execution of the transaction, loan payments for a loan used to finance the transaction, and refunds associated with product returns can each also involve money movement in real-time. In some cases, data and/or services may be exchanged amongst members, where specific needs or desires of the members are aligned with respect to playing their respective roles in connection with conducting a financial transaction, and enabling the settlement of the transaction, loan repayment and refunds for returns to all be conducted with money movement that occurs in real-time.

In some embodiments, for example, the application server 42 may therefore include an instance of a facilitation agent 44 comprising stored instructions for handling activities associated with practicing example embodiments as described herein. The facilitation agent 44 may be a technical device, component or module affiliated with the facilitator of the functioning of the SFP platform 10. Thus, the facilitation agent 44 may operate under control of the facilitator to be a technical means by which to carry out activities under direction of the facilitator or employees thereof. As such, in some embodiments, the clients 20 may access the SFP platform 10 services, and more particularly contact the facilitation agent 44 online and utilize the services provided thereby. However, it should be appreciated that in other embodiments, an application (e.g., the client application 22) enabling the clients 20 to interact with the facilitation agent 44 (or components thereof) may be provided from the application server 42 (e.g., via download over the network 30) to one or more of the clients 20 to enable recipient clients to instantiate an instance of the client application 22 for local operation such that the facilitation agent 44 may be a distributor of software enabling members or parties to participate in operation of the SFP platform 10. Alternatively, another distributor of the software may provide the client 20 with the client application 22, and the facilitation agent 44 may communicate with the client 20 (via the client application 22) after such download.

In an example embodiment, the client application 22 and/or software located at the facilitation agent 44 may therefore include application programming interfaces (APIs) and other web interfaces to enable the client 20 to conduct business via the SFP platform 10. The client application 22 may include instructions for generation of a series of control consoles or web pages including a landing page, onboarding services, activity feed, account settings (e.g., user profile information), transaction management services, payment management services and the like in cooperation with a service application that may be executed at the facilitation agent 44. Thus, for example, the client application 22 may enable the customer to review monthly statements, request a payment card 24 (e.g., a physical or virtual credit or debit card), turn on or off a virtual or digital card (each of which is an example of the payment card 24), access or adjust information associated with the customer account, initiate a transaction, make a loan repayment, manage a product return, or receive help or other information. Budgeting tools and other useful information and other useful tools for managing the finances of the customer may also be available via the client application 22 in some cases.

In an example embodiment, the application server 42 may include or have access to memory (e.g., internal memory or the database server) for storing instructions or applications for the performance of various functions and a corresponding processor for executing stored instructions or applications. For example, the memory may store an instance of the facilitation agent 44 configured to operate in accordance with an example embodiment of the present invention. In this regard, for example, the facilitation agent 44 may include software for enabling the application server 42 to communicate with the network 30 and/or the clients 20 for the provision and/or receipt of information associated with performing activities as described herein. Moreover, in some embodiments, the application server 42 may include or otherwise be in communication with an access terminal (e.g., a computer including a user interface) via which individual operators or managers of the entity associated with the facilitation agent may interact with, configure or otherwise maintain the SFP platform 10 and/or the facilitation agent 44.

As such, the environment of FIG. 1 illustrates an example in which provision of content and information associated with the financial industry (e.g., including at least some data provided to/from customers and/or merchants in real-time) may be accomplished by a particular entity (namely the facilitation agent 44 residing at the application server 42). Thus, the facilitation agent 44 may be configured to handle provision of content and information associated with tasks that are associated only with the SFP platform 10. Access to the facilitation agent 44 may therefore be secured as appropriate for the individuals or organizations involved and credentials of individuals or organizations attempting to utilize the tools provided herein may be managed by digital rights management services or other authentication and security services or protocols that are outside the scope of this disclosure.

The SFP platform 10 may also operate in cooperation with a first bank agent 50 (e.g., a computing device associated with a first bank), a second bank agent 54 (e.g., a computing device associated with a second bank), a third band agent 58 (e.g., a computing device associated with a third bank, and a merchant agent 60. The facilitation agent 44 may be configured to interact with, or otherwise facilitate interactions between, each of the first, second and third bank agents 50, 54 and 58, and/or the merchant agent 60 in order to carry out example embodiments as described herein. Thus, each of the first, second and third bank agents 50, 54 and 58, and/or the merchant agent 60 should be understood to be a computer, server, smart phone, or other technical component or module associated with a respective party (e.g., respective different banks or a merchant) that is capable of communication with other parties via the network 30, and under control of or responsive to facilitating communication by the facilitation agent 44.

One or more of the first, second and third bank agents 50, 54 and 58 may have a persistent relationship with the entity associated with the facilitation agent 44 (e.g., the facilitator) and/or with the customer (e.g., represented by client 20). However, for at least some bank entities, a persistent or pre-existing relationship with the customer is not required. However, each of the first, second and third bank agents 50, 54 and 58 may be contracted with or otherwise have a pre-existing relationship with the facilitation agent 44 (and entity associated therewith) that enables the facilitation agent 44 to facilitate transactions on behalf of the customer when certain conditions (agreed upon in advance by the entity associated with the facilitation agent 44 and the respective banks) are met associated with a transaction undertaken (or attempted) by the customer via the client 20 and client application 22. For example, the facilitator, or one of the banks, may be the issuer of the payment card 24 (e.g., debit or credit card) on behalf of the facilitation agent 44 and be responsible for directly paying the merchants and merchants during a transaction initiated by the customer via the payment card 24. However, as noted above, the payment card 24 is merely one example of a payment vehicle that could be used in association with sending/receiving payments in association with an example embodiment.

In some embodiments, the first bank agent 50 may be associated with a first bank at which the customer (i.e., associated with one of the clients 20) deposits money in a bank account such as a savings account or a checking account. In an example embodiment, the customer may subscribe or register to a service or request the payment card 24 (e.g., a credit card, debit card or other virtual or digital card) from the facilitation agent 44 to enroll the customer as a member of the SFP platform 10. During subscription or registration, the customer may be prompted (via the client 20 and client application 22) by the facilitation agent 44 to provide account details identifying the savings account or checking account (i.e., a customer account) at the first bank. The customer may, by registering or subscribing, further authorize the facilitation agent 44 to conduct specific activities related to the customer account when corresponding conditions are met, which may be facilitated by the facilitator. The activities may include checking account status (i.e., checking a current balance of funds deposited in the customer account) and/or authorizing withdrawal of funds from the customer account by a payment processor 80 in order to settle a transaction or make payments to the facilitation agent 44.

If included, the payment processor 80 may be an agent or service that facilitates the acceptance and/or sending of payments between parties online. Thus, for example, the payment processor 80 may utilize its own software, application programming interfaces (APIs) or the like that define an infrastructure or payment platform to connect businesses or companies to manage their businesses or transactions online.

In some cases, different customers may have different banks (and corresponding bank agents). Similarly, the merchant agent 60 may change for each respective transaction since different merchants may be involved in different transactions involving the clients 20. In some examples, a bank authentication agent may provide authentication services, and the payment processor 80 may remain the same entities across all transactions managed by the facilitation agent 44. However, the facilitation agent 44 could use different bank authentication agents in different geographic areas or jurisdictions, and the payment processor 80 may also change on the same bases.

As noted above, the SFP platform 10 may operate to enable the customer associated with a given one of the clients 20 to make a purchase (e.g., in real time) from a merchant associated with the merchant agent 60. In some example embodiments, the client application 22 may be used in connection with setting up the account details that are then used as the basis for managing interactions between the parties shown in FIG. 1 under control of the facilitation agent 44. In this regard, for example, the client application 22 may be used to engage (e.g., via a website and corresponding APIs) with the facilitation agent 44 to set up an account with the facilitation agent 44 for services associated with the SFP platform 10. The facilitation agent 44 may prompt the client 20 to provide account details associated with the first bank agent 50 and may provide terms and conditions (electronically or via mail or other communication means) that the customer may accept to establish a user profile and user account with the facilitation agent 44. In some cases, the customer may be provided with the payment card 24 (e.g., a debit card or credit card) or other physical implement that can be used to initiate transactions with merchants.

As noted above, the payment card 24 may be issued by the issuing bank. The payment card 24 may be associated with the user account, and may provide identifying information needed to initiate operation of the SFP platform 10 (and the facilitation agent 44) as described herein when the customer uses the payment card 24 to make a purchase with a merchant. The payment card 24 may be physically presented for such purpose and magnetic strip, chip or other technologies may be used in connection with initiating the transaction. Otherwise, the card number provided on the payment card 24 may be unique to the user account, and may be provided to the merchant to initiate the transaction. Finally, as an additional or alternative way to initiate a transaction, the payment card 24 may be virtual and may exist in a mobile wallet or other smartphone context for initiating transactions online. In such a context, the client application 22 may also or alternatively be the means by which the transaction is initiated or handled. Thus, it should be appreciated that the client application 22 could be used to set up the user account and user profile and/or to conduct individual transactions.

During establishment of the user account or customer account, the customer may provide an identification of the first bank associated with the first bank agent 50, and may also provide details for the savings or checking account that the customer maintains at the first bank. The customer may also authorize the facilitation agent 44 to make real time (or anytime) checks on account status (e.g., account balance) or to make periodic routine checks of the same. Thus, for example, for each transaction, the facilitation agent 44 may be enabled to check the account balance of the customer. Alternatively or additionally, the facilitation agent 44 may make routine checks or snapshot looks at the account balance. For example, a check may be made every day at a certain time, every two or three days, or at other standard or random intervals. The account status of the first bank may be used by the facilitation agent 44 in facilitating payment transactions, such as determining whether a debit transaction can be facilitated, or whether a loan can be granted to support the transaction(s).

The second bank may have an agreement or relationship with the entity associated with the facilitation agent 44 (i.e., the facilitator) that enables the facilitation agent 44 to engage the second bank to extend funds to a merchant or vendor on behalf of the customer in response to instruction from the facilitation agent 44. The facilitation agent 44 may therefore coordinate communications and funds transferring between members or parties of the SFP platform 10 to facilitate payment transactions that can be handled in ways selected specifically by the customer. In this regard, the customer may approach the merchant (physically or virtually) in order to initiate a transaction. The payment card 24 (virtual or physical) may be provided for payment, and the corresponding indication of a pending transaction may be communicated (e.g., via the SFP platform 10 by the merchant agent 60 and/or the client 20 via the network 30). The transaction may be associated with a loan in some cases, or with a product refund in others, and flow of funds reserved for the loan or refund may be managed by the facilitation agent 44 without any further need for customer interaction. The communication and activities that ensue from the basic description above will now be described greater detail below.

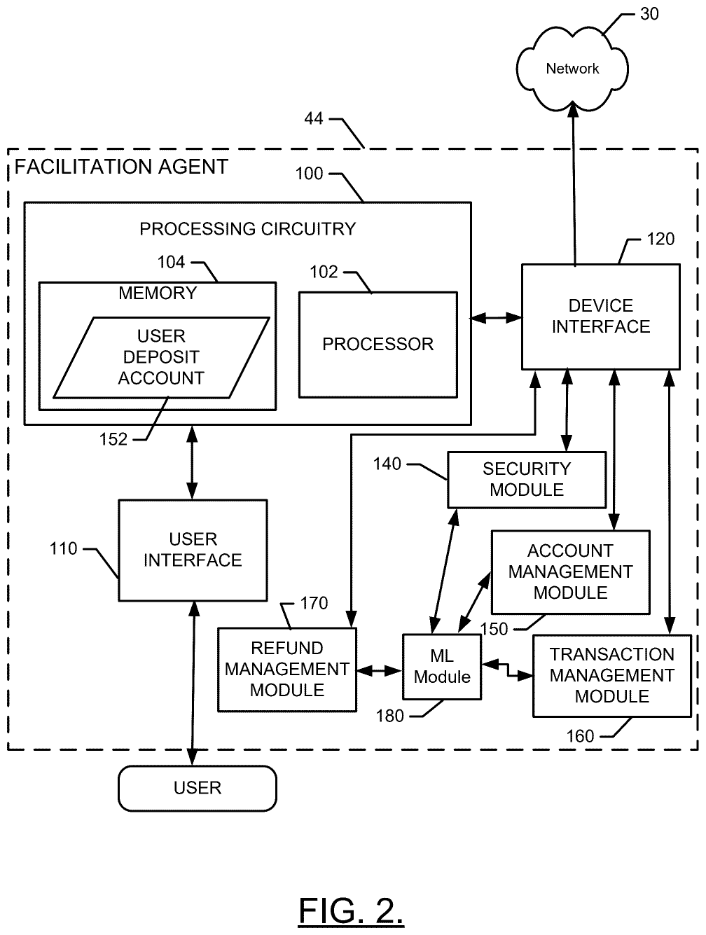

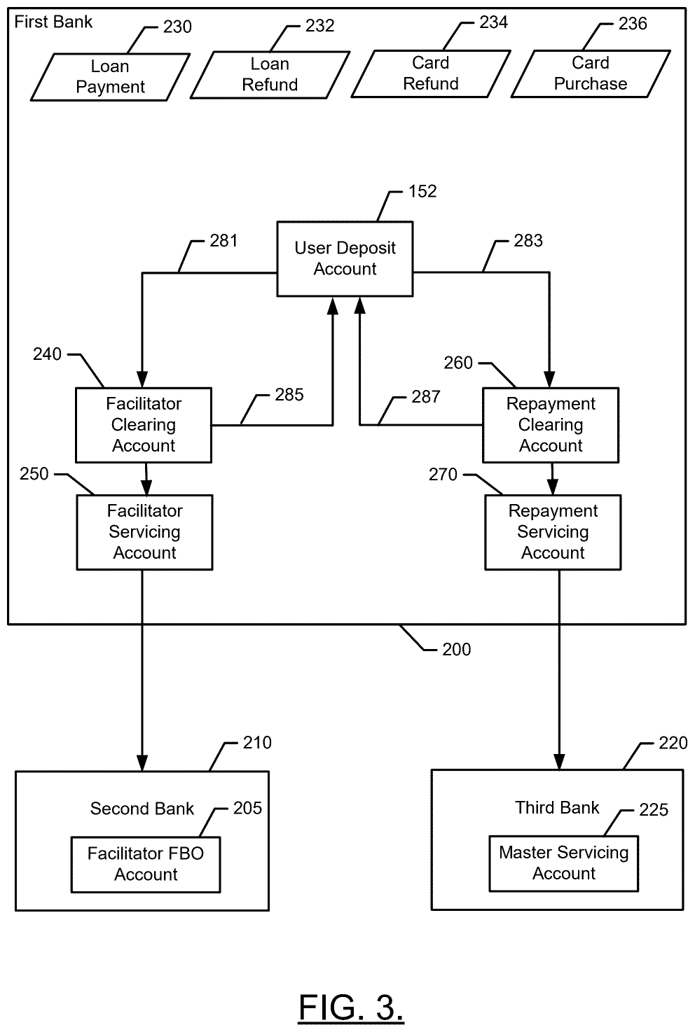

Regardless of how the transactions are initiated, the SFP platform 10 of FIG. 1 may be used before, during and after the time of the transaction in order to enable the facilitation agent 44 to set up the user account, make determinations necessary to approve a loan in association with a planned transaction prior to its initiation, conduct the transaction in real time responsive to initiation of the transaction, facilitate flow of funds and issuance of the loan and managing the flow of funds accordingly at the appropriate time. The SFP platform 10 may also support product return and refund activities as described in greater detail below. Each of these activities may have its own respective timing and communications that are facilitated by the facilitation agent 44 and FIGS. 3-8 illustrate example scenarios. However, prior to examining each respective scenario, the structures associated with an apparatus at which the facilitation agent 44 of an example embodiment may be instantiated will be described in reference to FIG. 2.

FIG. 2 shows certain elements of an apparatus for provision of the facilitation agent 44 or other processing circuitry according to an example embodiment. The apparatus of FIG. 2 may be employed, for example, as the facilitation agent 44 itself operating at, for example, a network device, server, proxy, or the like (e.g., the application server 42 of FIG. 1)). Alternatively, embodiments may be employed on a combination of devices (e.g., in distributed fashion on a device (e.g., a computer) or a variety of other devices/computers that are networked together). Accordingly, some example embodiments may be embodied wholly at a single device (e.g., the application server 42) or by devices in a client/server relationship (e.g., the application server 42 and one or more clients 20). Thus, although FIG. 2 illustrates the facilitation agent 44 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating an exchange for information and services associated therewith in the financial industry is provided. The apparatus may be an embodiment of the facilitation agent 44 or a device of the SFP platform hosting the facilitation agent 44. As such, configuration of the apparatus as described herein may transform the apparatus into the facilitation agent 44. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In situations where the processing circuitry 100 is embodied as a server or at a remotely located computing device, the user interface 110 may be disposed at another device (e.g., at a computer terminal) that may be in communication with the processing circuitry 100 via the device interface 120 and/or a network (e.g., network 30).

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, as indicated above, the user interface 110 may be remotely located (e.g., at the user interface of the client 20).

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server) that may store a variety of files, contents or data sets. Among the contents of the memory 104, applications (e.g., a service application configured to interface with the client application 22) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the facilitation agent 44, which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 as described below.

The facilitation agent 44 may be configured to include tools to facilitate the creation of customer or user accounts (and a corresponding user profile), and the coordination of communication and fund transfers to support the operations of the SFP platform 10 as described herein. The tools may be provided in the form of various modules that may be instantiated by configuration of the processing circuitry 100. FIG. 2 illustrates some examples of modules that may be included in the facilitation agent 44 and that may be individually configured to perform one or more of the individual tasks or functions generally attributable to the facilitation agent 44 according to an example embodiment. However, the facilitation agent 44 need not necessarily be modular. In cases where the facilitation agent 44 employs modules, the modules may, for example, be configured to perform the tasks and functions described herein. In some embodiments, the facilitation agent 44 and/or any modules comprising the facilitation agent 44 may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 and/or any modules thereof, as described herein. However, as noted above, the modules described herein may not be separate modules or modular in that respect. Thus, functions associated with each module described herein may be distributed or consolidated in part or in whole in various example embodiments.

As shown in FIG. 2, the facilitation agent 44 may include a security module 140. The security module 140 may be configured to enforce data security and data/user access control. In some example embodiments, the security module 140 may employ authentication and authorization tools to manage the provision of access to customers or other SFP platform 10 members or entities wishing to access the SFP platform 10. The security module 140 may operate on queries or communications in real time as such queries or communications are occurring.

The facilitation agent 44 may also include an account management module 150. The account management module 150 may be configured to manage storage of and access to information about individual customers including user accounts and corresponding user profiles, which may include descriptive information about settings, approvals, or management paradigms that apply to specific merchants or transactions for each instance of the user accounts. The user accounts may include details of the checking or savings account at the customer bank for each customer and respective client 20, and authorizations to check account status for each. In FIG. 2, an example of a user or customer account is shown by user deposit account 152.

In an example embodiment, the account management module 150 may handle communications with the clients 20 associated with setting up the user deposit account 152 (e.g., at the first bank, via communication with the first bank agent 50). The user profile associated with each respective one of the user accounts exemplified by the user deposit account 152 may include user preferences, entitlements, or authorizations (e.g., credit limits) with respect to the amount of debt each user is enabled to take on either in aggregate, on a transaction by transaction basis, on a merchant basis, or with respect to specific types of goods or services. Each transaction may, for example, be authorized only if rules associated with either user preferences or policies that the customer has reviewed and accepted as terms of service are met. Those rules may be established during account setup and recorded for each of the instances of the user deposit account 152 by the account management module 150.

In an example embodiment, the facilitation agent 44 may also include a transaction management module 160. The transaction management module 160 may coordinate or facilitate all communications with the parties to the SFP platform 10 in association with each transaction that is initiated by a customer, and including (in some cases) each transaction that is planned by a customer in advance. As such, the transaction management module 160 may be configured to handle communications with the client 20, the merchant agent 60, any of the first, second and third bank agents 50, 54 and 58, and the payment processor 80 as described in greater detail below in response to and prior to handling a transaction. In the responsive case, for example, the transaction management module may receive an indication of a pending transaction and, within a predetermined period of time (e.g., 3 seconds) make a determination as to whether to authorize the transaction or deny the transaction. The decision to authorize or deny the transaction may be made based on either a real time and concurrent check on the account status (e.g., account balance) of the checking or savings account identified in the user deposit account 152, or based on the last snapshot of the account status (assuming the snapshot was taken within a predetermined period of time (e.g., 3 days or less). If the account status is satisfactory, the transaction may be authorized, and further communications and coordination details described below may be handled by the transaction management module 160. The transaction management module 160 may also be configured to, assuming certain criteria are met, provide the customer with options for either immediate settlement relative to the transaction as a debit transaction, or whether to convert the transaction to an installment loan with predetermined (or customer selected) payment terms.

In some embodiments, the facilitation agent 44 may further include a refund management module 170. The refund management module 170 may be configured to provide generation of appropriate messages, control consoles or user interface displays (e.g., at the client 20) by provision of corresponding instructions to do so for the control of various activities associated with managing a return and its associated refund. In this regard, in some cases the customer may initially engage with the refund management module 170 to proactively report a product return. The customer may have recently completed the product return, or may be planning to do so shortly, and may wish to arrange for the handling of the corresponding refund. In such cases, the refund management module 170 may manage the interface tools to enable the customer to set up the handling of the refund money. However, in other cases, the customer may not necessarily initiate the refund activity, and the refund money may simply show up at the facilitator in response to the product return. In such cases, the refund management module 170 may include programming to automatically process the refund money.

In some embodiments, in response to the receipt of refund money from a merchant, the refund management module 170 may access stored information regarding prior transactions that the customer has conducted recently with the merchant to see if any of the transactions appear to match the refund. For example, if the refund amount is $200 and there is only one transaction for $200 (either alone or among other transactions for different monetary values), it may be clear that there is a merchant match and a refund amount match indicating receipt of a full refund from the merchant for the amount of the transaction. The refund management module 170 may then determine the type of transaction that was conducted (i.e., the payment option selected for the transaction), and may process the refund money according to a refund path that is appropriate to that type of transaction or payment option.

In some cases, the facilitation agent 44 may further include a machine learning (ML) module 180. The machine learning module 180 (if employed) may be further employed by (or distributed within) respective ones of the security module 140, the account management module 150, the transaction management module 160 and/or the refund management module 170 to enhance the capabilities of each respective module for use in scaled environments where the volume and velocity of data that are to be processed are so massive that normal computational resources are not sufficient to the tasks at hand.

The machine learning module 180 may employ one or more instances of a neural network (e.g., a CNN), a support vector machine (SVM), Bayesian network, logistic regression, logistic classification, decision tree, ensemble classifier or other machine learning model to process inputs received by the machine learning module 180 to generate outputs as described herein. The machine learning module 180 may be supervised (identifying patterns in raw data upon which inference processes are desired to be performed via training examples) or unsupervised (identifying patterns in raw data upon which inference processes are desired to be performed without training examples). In an example embodiment, the machine learning module 180 may include a neural network of nodes where each node includes input values, a set of weights, and an activation function. The neural network node may calculate the activation function on the input values to produce an output value. The activation function may be a non-linear function computed on the weighted sum of the input values plus an optional constant. Neural network nodes may be connected to each other such that the output of one node is the input of another node. Moreover, neural network nodes may be organized into layers, each layer comprising one or more nodes. The neural network may be trained and update its internal parameters via backpropagation during training. A CNN may be a type of neural network that further adds one or more convolutional filters (e.g., kernels) that operate on the outputs of the preceding neural network layer to produce and output to then next layer. The convolutional filters may have a window in which they operate, which is spatially local. A node of a preceding layer may be connected to a node in the current layer if the node of the preceding layer is within the window. If not within the window, then the nodes are not connected.

In an example embodiment, training may occur via the provision of training data along with target data that includes desired output data associated achieved from the training data via respective models stored in the memory 104 and accessible to the machine learning module 180. Thereafter, when inferences are to be drawn with respect to a new set of data including new information to provide an output that is indicative of options for output, training backpropagation may be provided to update the learning. The information provided to the machine learning module 180, and the corresponding outputs to be gained therefrom, may vary. Thus, for example, the machine learning module 180 may, in some cases, be employed by the security module 140 to enhance security performance. In such cases, for example, massive amounts of real time account activity across a multitude of instances of the user deposit account 152 may be simultaneously monitored. Specific potential instances of fraud may be detectable in real time, whereas others may only be detectable by monitoring patterns that play out over longer periods of time. The machine learning module 180 may assist in load balancing between real time fraud detection resources and post hoc fraud detection resources of the security module 140. As such, the load balancing function may effectively triage massive amounts of data into respective camps that dictate how quickly fraud detection resources are to be employed for detecting suspicious activity. In such capacity, the machine learning module may not only conduct load balancing, but may schedule individual fraud monitoring activities at specific future times during which resources for fraud detection are expected to be available for the corresponding type or priority of data being analyzed for fraudulent activity.

In some embodiments, the account management module 150 and/or the transaction management module 160 may leverage resources of the machine learning module 180 for enhanced liquidity management. In this regard, for example, the machine learning module 180 may monitor activity associated with the user deposit account 152 (of either just one user or of a plethora of users simultaneously) to determine amounts of liquidity needed for each respective account across various timeframes that may be of interest including days of the month or week, or even times of day. The knowledge of liquidity information may ensure that overdrafts are avoided and failed ACH transfers are also avoided. In some cases, the machine learning module 180 may also identify opportunities to take/move money in chunks that will be supportable at the time such chunks are moved. Thus, for example, if a total transaction is $1000, but it can be inferred that only $300 is reliably available until a certain date or time, the machine learning module 180 may limit movement of money to $300 until the certain date or time is reached, this process may be repeated until the full $1000 is ultimately moved to support the transaction as appropriate.

Regardless of the specific form of the machine learning module 180, machine learning may be performed to perform inferences with respect to massively large volumes of data that would take normal computer processing very long periods of time to handle. The machine learning module 180 can handle massive volumes of data, and identify the data pertinent to a given user, a given merchant, a given situation or scenario, etc., within constraints that may be unique to the given user, merchant, situation, etc., in the context of mountains of information, within seconds, whereas doing so with conventional processing tools (i.e., without machine learning) would take orders of magnitude longer periods of time. The machine learning module 180 therefore enables an acceleration of the processing needed to conduct processing of data, but also to find deep patterns that are meaningful with respect to providing options that are most likely to be acceptable to the given user or situation within constraints that apply.

The general system architecture of FIG. 1 and the general componentry of the facilitation agent 44 of FIG. 2 provide a context via which a distributed payment system may be provided to enable pay now and pay later purchases to be handled (along with refunds) in a seamless way that actually facilitates real-time money movement when the account (e.g., the user deposit account 152) that supports the payment card 24 is at a bank that is different from the card issuer. The system architecture of FIG. 1 and the componentry of FIG. 2 may therefore enable coordination of communication and money transfers via a distributed payment system that is defined by a unique environment or context that is shown in greater detail in FIG. 3

Referring now to FIG. 3, the user deposit account 152 may exist or be maintained at a first bank 200 (e.g., associated with the first bank agent 50 of FIG. 1). The card issuer or facilitator may, in the meantime, maintain a facilitator FBO account 205 (or any other pooled set of funds at a depository bank including a direct deposit account) at a second bank 210 (e.g., associated with the second bank agent 54 of FIG. 1). For some transactions (e.g., loan repayments), a third bank 220 (e.g., associated with the third bank agent 58 of FIG. 1) having a master servicing account 225 may also be involved. The master servicing account 225 may be an account in which loan payments via a payment service such as the payment processor 80 are sent. The user deposit account 152 may be involved in money transfers and therefore flows of funds associated with various activities including, for example, a loan payment 230, a loan refund 232, a card refund 234 and a card purchase 236.

As noted above, in a typical situation in which the account (e.g., the user deposit account 152) that supports the payment card 24 is at a bank that is different from the card issuer, movement of money happens over predefined and generally relatively slow time periods, which can cause intervening events to render earlier account status information inaccurate when the time to actually make a transfer arrives. This can cause overdrafts, fails ACH transfers or other inconveniences. To address this issue and create a distributed payment system that can handle real time money transfers, the facilitator may establish a facilitator clearing account 240 at the first bank 200 along with a facilitator servicing account 250. Each of the facilitator clearing account 240 and the facilitator servicing account 250 may be for benefit of (FBO) accounts managed by the facilitator on behalf of payment card holders affiliated with the first bank 200. The facilitator clearing account 240 and the facilitator servicing account 250 may be used to support money movement instantaneously (or nearly so) in connection with refunds, authorization and capture of funds associated with various transactions or returns. The facilitator clearing account 240 may hold unreconciled funds and may be transacted against based on the occurrence of various trigger events noticed by the facilitator. The facilitator servicing account may hold reconciled funds to be transferred based on instructions from the facilitator.

Meanwhile, the facilitator may also establish a repayment clearing account 260 at the first bank 200 along with a repayment servicing account 270. Each of the repayment clearing account 260 and the repayment servicing account 270 may each be direct deposit accounts (DDAs) managed by the facilitator on behalf of payment card holders affiliated with the first bank 200 to hold only funds for loan repayment. The repayment clearing account 260 and the repayment servicing account 270 may be used to support money movement instantaneously (or nearly so) in connection with loan repayments, particularly when a loan repayment is impacted by a refund or return. The repayment clearing account 260 may hold unreconciled funds transacted against by the facilitator via system triggers. The repayment servicing account 270 may hold reconciled funds to be instructed for payments associated with loan repayment to the third bank 220 associated with the facilitator.

At the time of a transaction involving the loan payment 230 or card purchase 236 discussed above, the user or customer may use the payment card 24 to make either a purchase or make a payment in association with a loan established for a prior purchase. Each of these activities may be considered to be the basis of an initiation of funds flowing within the system of FIG. 3, and may cause funds to flow from the user deposit account 152 to the facilitator clearing account 240 for the card purchase 136 in accordance with flow path 281, or to flow from the user deposit account 152 to the repayment clearing account 260 for the loan payment 230 in accordance with flow path 283. Thus, for example, the purchase or payment amount may be credited from the user deposit account 152 to the corresponding clearing account of the facilitator.

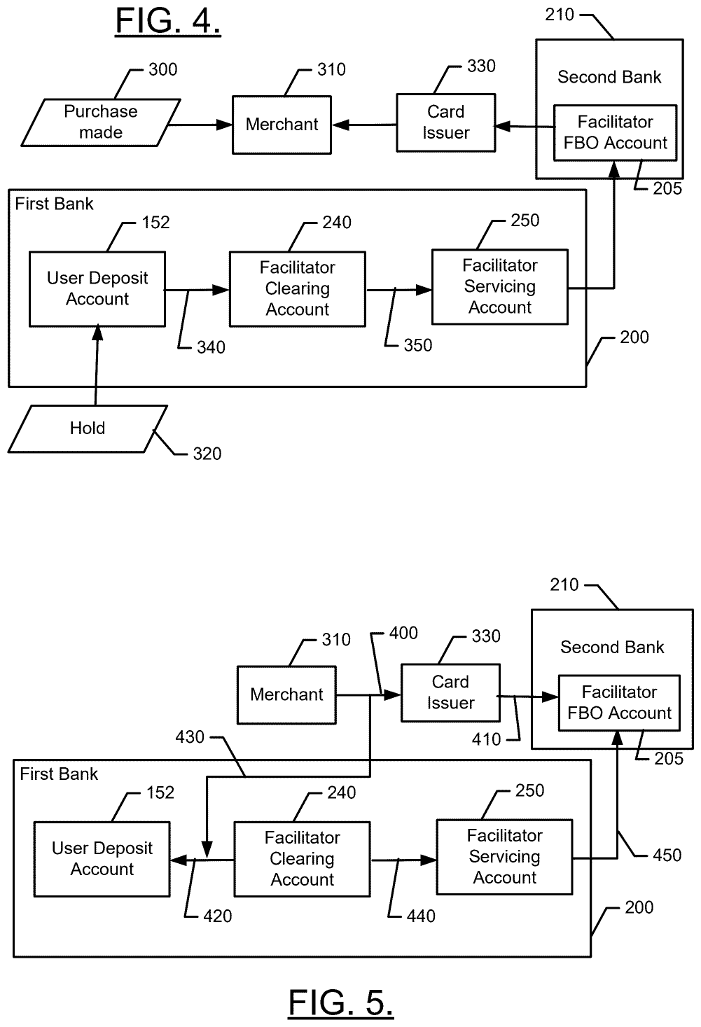

Alternatively, for the card refund 234, the customer may receive a refund, and the refund amount may be debited from the facilitator clearing account 240 to the user deposit account 152 at flow 285. If instead a transaction is the loan refund 232, the customer may receive a payment reversal and the reversed payment amount may be debited from the repayment clearing account 260 to the user deposit account 152 at flow 287. These flows into and out of the user deposit account 152, and the clearing accounts may continue all day for multiple transactions, as applicable. At the end of the same day, a net of purchases or refunds and/or payments/reversals may be calculated and may be debited from the facilitator clearing account 240 to the facilitator servicing account 250, or from the repayment clearing account to the repayment servicing account 270. Thereafter, e.g., typically the next business day, the net sum of purchases or payments less any refunds or reversals, may be wired from the facilitator servicing account 250 to facilitator FBO account 205 at the second bank 210, or from the repayment servicing account 270 to the master servicing account 225 of the third bank 220. Specific scenarios will now be described in connection with FIGS. 4-8.

When a user makes a purchase using the payment card 24, there may be multiple variables that affect the timing of money movement from the user deposit account 152. For example, if the user makes certain purchases of products that are eligible to be split (e.g., converted into split payments over a period of time), the user may be given a period of time during which to make a decision about the splitting option. This period of time may necessitate a delay to the transfer of funds that is addressed by the example above that is described in reference to FIG. 4. Another variable that may affect timing is that when a transaction is made using the payment card 24 either authorization or capture may occur. If both authorization and capture occur at the same time, the event is called a perfect capture, which is the scenario described above in reference to FIG. 4. If the events occur separately, authorization generally happens before capture but it should be appreciated that capture may not always occur (e.g., when a transaction is voided).

Authorization is an initial card network event that is sent to “approve” a card transaction, which includes the initial amount of the transaction. This generally appears as “pending” in a user's transaction history. Authorization is necessary for purchases that may incur a total cost that is different from the initial card swipe amount. Capture is a subsequent card network event that finalizes the card transaction with the total amount of the purchase. Thus, for example, if a meal at a restaurant is $100, and a tip of $20 is added, the initial authorization would be for $100, but the amount captured would be $120.

Turning first to FIG. 4, a flow of funds for authorization and capture in accordance with an example embodiment is shown. As shown in FIG. 4, a purchase 300 is made at a merchant 310 (e.g., associated with the merchant agent 60 of FIG. 1) using the payment card 24 (e.g., via a swipe or online transaction). A hold 320 may immediately be placed on the user deposit account 152 in the amount of the purchase 300. Card issuer 330 (e.g., a credit card company or the facilitator) may then take money from the facilitator FBO account 205 at the second bank 210 equal to the amount of the purchase 300, and provide the money taken from the facilitator FBO account 205 (in the amount of the purchase 300) to the merchant 310.

Upon capture or expiration of a delay period (e.g., 24 hours during which an option to split payments may expire), the amount of the purchase 300 may be debited from the user deposit account 152 as shown at operation 340 and credited to the facilitator clearing account 240. At the end of the day after either capture or the split expiration noted above, the amount of the purchase 300 may be credited to the facilitator servicing account 250 as shown by operation 350. Thereafter (e.g., a day later), the facilitator may instruct wiring of funds from the facilitator servicing account 250 to the facilitator FBO account 205 at the second bank 210. Whereas many card issuers have the same bank as the bank at which the user deposit account occurs, so transferring funds is trivial and can quickly be accomplished, the separation of these banks (as is the case in FIG. 4) non-trivializes the transfer of funds. Thus, it is via the distributed payment system of FIG. 3 and the processes described above that real time movement of funds can be realized to back a transaction.

FIG. 5 shows the flow of funds for a refund of a transaction originally performed with the payment card 24. As shown in FIG. 5, the merchant 310 may issue a refund to the card issuer 330 at operation 400 for a refund amount. The refund amount may then be credited to the facilitator FBO account 205 at the second bank 210 at operation 410. The user deposit account 152 may then also be credited with the refund amount from the facilitator clearing account 240 at operation 420 responsive to a system trigger or trigger event 430. At the end of the day, net purchases less refunds may be credited from the facilitator clearing account 240 to the facilitator servicing account 250 at operation 440. Thereafter, at operation 450, the facilitator may instruct wiring or otherwise transferring the refund amount from the facilitator servicing account 250 to the facilitator FBO account 205 at the second bank 210 to record that the refund amount has been received. In this context, all of operation 400 to 440 may be substantially executed in real time.

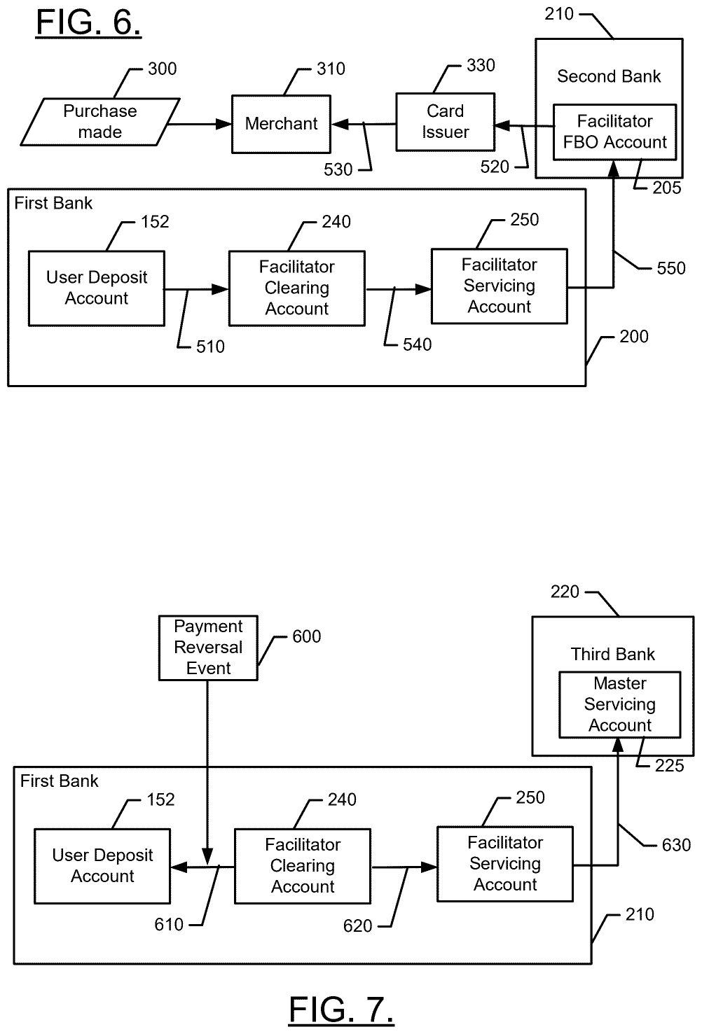

FIG. 6 shows a flow of funds for a perfect capture situation in accordance with an example embodiment. As shown in FIG. 6, a purchase 500 is made at the merchant 310 using the payment card 24 (e.g., via a swipe or online transaction). The amount of the purchase 500 may be debited from the user deposit account 152 as shown at operation 510 and credited to the facilitator clearing account 240. Card issuer 330 may then take money from the facilitator FBO account 205 at the second bank 210 equal to the amount of the purchase 500 at operation 520, and provide the money taken from the facilitator FBO account 205 (in the amount of the purchase 500) to the merchant 310 at operation 530. At the end of the day, the amount of the purchase 500 may be credited to the facilitator servicing account 250 as shown by operation 540. Thereafter (e.g., a day later), the facilitator may instruct wiring of funds from the facilitator servicing account 250 to the facilitator FBO account 205 at the second bank 210 at operation 550.

FIG. 7 shows the flow of funds for a refund of a transaction originally performed with the payment card 24 for which a loan was obtained. As shown in FIG. 7, a payment reversal event may occur at operation 600 for a refund amount. The refund amount may then be credited to the user deposit account 152 from the facilitator clearing account 240 at operation 610. At the end of the day, net purchases less refunds may be credited from the facilitator clearing account 240 to the facilitator servicing account 250 at operation 620. Thereafter, at operation 630, the facilitator may modify loan ledger system records to reflect an adjustment of the outstanding loan amount balance or otherwise instruct wiring or otherwise transferring the refund amount from the facilitator servicing account 250 to the master servicing account 225 at the third bank 220 to record that the refund amount can be subtracted from any expected payment (e.g., on a loan triggered by the purchase to which the refund applied).

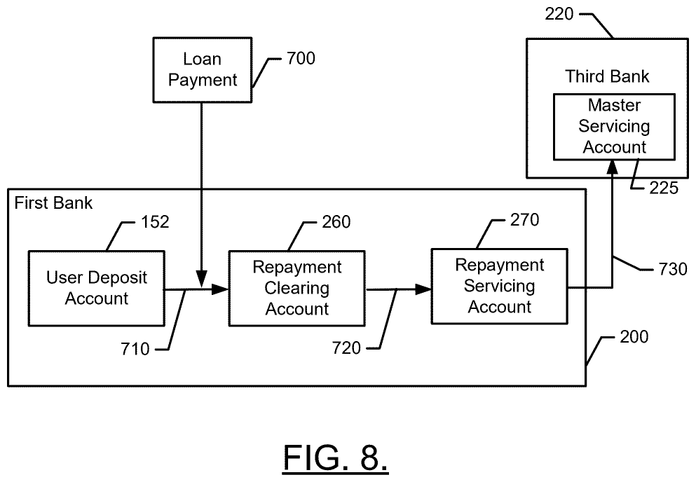

FIG. 8 shows the flow of funds when the user or customer repays a loan from the user deposit account 152. In this regard, at operation 700, the user makes a loan payment. Immediately responsive to operation 700, the amount of the loan payment may be debited from the user deposit account 152 and credited to the repayment clearing account 260 at operation 710. At the end of that day (e.g., the end of the business day or end of the actual day), the amount of the loan payment may be debited from the repayment clearing account 260 and credited to the repayment servicing account 270 at operation 720. Thereafter, typically the next business day, the facilitator may instruct transfer or wiring of funds matching the amount of the loan payment from the repayment servicing account 270 to the master servicing account 225 at operation 730.

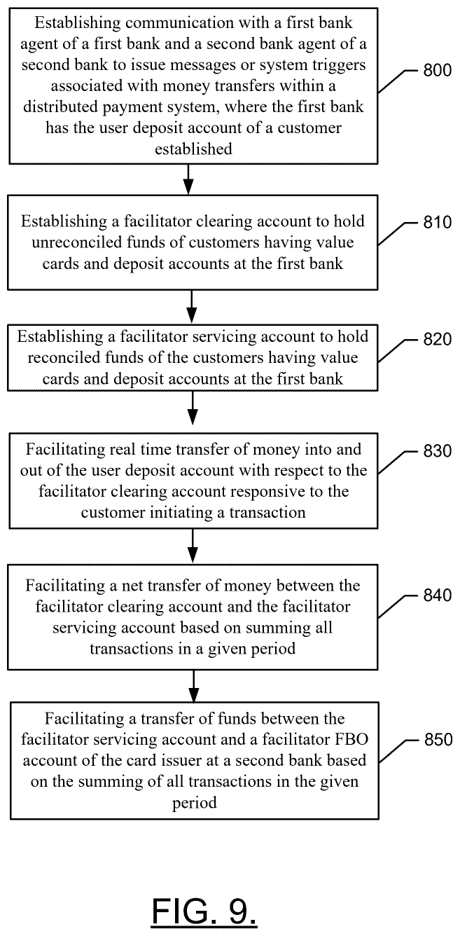

From a technical perspective, the SFP platform 10, and more particularly the facilitation agent 44, described above may be used to support some or all of the operations described above. As such, the apparatus described in FIG. 2 may be used to facilitate the implementation of several computer program and/or network communication based interactions. As an example, FIG. 9 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 42, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method of processing a customer transaction associated with a payment vehicle (e.g., a payment card) in a system where the user deposit account of the customer is at one bank and the issuer of the payment card has its account (e.g., an FBO account) for servicing the payment card at another bank according to one embodiment of the invention is shown in FIG. 9. The method may include establishing communication with a first bank agent of a first bank and a second bank agent of a second bank to issue messages or system triggers associated with money transfers within a distributed payment system, where the first bank has the user deposit account of a customer established at operation 800. The method may further include establishing a facilitator clearing account to hold unreconciled funds of customers having payment cards and deposit accounts at the first bank at operation 810, establishing a facilitator servicing account to hold reconciled funds of the customers having payment cards and deposit accounts at the first bank at operation 820, and facilitating real time transfer of money into and out of the user deposit account with respect to the facilitator clearing account responsive to the customer initiating a transaction at operation 830. The method may also include facilitating a net transfer of money between the facilitator clearing account and the facilitator servicing account based on summing all transactions in a given period at operation 840, and facilitating a transfer of funds between the facilitator servicing account and a facilitator account (e.g., a for benefit of (FBO) account) of the card issuer at a second bank based on the summing of all transactions in the given period at operation 850.

In an example embodiment, an apparatus for performing the method of FIG. 9 above may comprise a processor (e.g., the processor 102) or processing circuitry configured to perform some or each of the operations (800-850) described above. The processor may, for example, be configured to perform the operations (800-850) by performing hardware implemented logical functions, executing stored instructions, or executing algorithms for performing each of the operations. In some embodiments, the processor or processing circuitry may be further configured for additional operations or optional modifications to operations 800 to 850.

A distributed payment system may therefore be provided to include a first bank at which a user deposit account of a customer is established where the user deposit account is associated with a payment vehicle such as, for example, a payment card of the customer to fund transactions initiated via the payment card, a second bank at which a facilitator account (e.g., a facilitator FBO account) of a card issuer of the payment card is established, and a facilitation agent in communication with a first bank agent of the first bank and a second bank agent of the second bank to issue messages or system triggers associated with money transfers within the distributed payment system. The facilitation agent establishes a facilitator clearing account to hold unreconciled funds of customers having payment cards and deposit accounts at the first bank, and establishes a facilitator servicing account to hold reconciled funds of the customers having payment cards and deposit accounts at the first bank. The facilitation agent facilitates real time transfer of money into and out of the user deposit account with respect to the facilitator clearing account responsive to the customer initiating a transaction, facilitates a net transfer of money between the facilitator clearing account and the facilitator servicing account based on summing all transactions in a given period, and facilitates a transfer of funds between the facilitator servicing account and the facilitator FBO account of the second bank based on the summing of all transactions in the given period.

In some embodiments, the system may include additional components/modules, optional operations/capabilities, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, the transaction may be a purchase made with the payment card at a merchant for a purchase amount and immediately responsive to the purchase being made, the facilitator may issue a hold on the user deposit account and the purchase amount is transferred from the facilitator FBO account to the merchant. Responsive to the purchase amount being transferred from the facilitator FBO account to the merchant, the facilitator may then debit the user deposit account by the purchase amount and credit the purchase amount to the facilitator clearing account. In an example embodiment, the transaction may be a refund on a prior purchase made with the payment cards at a merchant for a purchase amount, and the refund is for a refund amount matching the purchase amount and immediately responsive to the refund amount being returned by the merchant, the facilitator may transfer the refund amount to the facilitator FBO account to the merchant. Responsive to the refund amount being transferred to the facilitator FBO account to the merchant, a system trigger may causes a debit of the facilitator clearing account by the refund amount and the refund amount is credited to the user deposit account. In some cases, the transaction may be a purchase made with the payment card at a merchant for a purchase amount and immediately responsive to the purchase being made, the facilitator may transfer the purchase amount from the facilitator FBO account to the merchant. Responsive to the purchase amount being transferred from the facilitator FBO account to the merchant, the facilitator may debit the user deposit account by the purchase amount and credit the purchase amount to the facilitator clearing account. In an example embodiment, the transaction may be a payment reversal on a prior purchase made with the payment card at a merchant for a purchase amount, and immediately responsive to the payment reversal being initiated, a system trigger may cause a debit of the facilitator clearing account by the refund amount and the refund amount may be credited to the user deposit account. A net of all transferred money with respect to the facilitator clearing account in a given time may be transferred with respect to the facilitator servicing account at the end of the given time, and after the given time, the facilitator may transfer the net of all transferred money from the facilitator servicing account to a master servicing account of a third bank. In some cases, the facilitator may further establish a repayment clearing account and a repayment servicing account at the first bank. The transaction may be a loan payment associated with a loan made with respect to a purchase using the payment card, where the loan payment has a payment amount. Immediately responsive to the loan payment, the user deposit account may be debited by the payment amount and the payment amount may be credited to the repayment clearing account. The payment amount is debited from the facilitator clearing account and credited to the facilitator servicing account at the end of a given time. After the given time, the facilitator may transfer the payment amount from the facilitator servicing account to a master servicing account of a third bank to deduct the payment amount from an outstanding loan balance associated with the loan. In an example embodiment, the system may further include a machine learning module. The machine learning module may employ load balancing with respect to system resources for fraud detection. Alternatively or additionally, the machine learning module may schedule individual fraud monitoring activities. Alternatively or additionally, the machine learning module may monitor account liquidity information of the user deposit account over time to reduce a risk of overdraft from the user deposit account. Alternatively or additionally, the machine learning module may further monitor liquidity information for a plurality of user deposit accounts to simultaneously reduce a risk of overdraft from each of the plurality of user deposit accounts. Alternatively or additionally, the machine learning module may reduce the risk of overdraft by scheduling two or more partial transfers less than an amount of the transaction until the amount of the transaction has been transferred at times selected based on a likelihood of funds being available in the user deposit account to support an individual partial transfer at a corresponding time.

Example embodiments therefore provide technical tools for handling of funds associated with purchases or refunds in situations where the payment vehicle (e.g., payment card) user account and facilitator (card issuer) account are at different banks, in a way that allows the funds to be instantaneously moved with respect to the user deposit account to ensure real time accuracy with respect to the amount in the account so that other transactions and decision associated therewith can be conducted with confidence in the amounts reflected in the account at any given time. Where such instantaneous handling is not possible, ambiguity exists that increases the risks of transacting in various ways to all participants. Thus, while example embodiments do not seek to directly manage or reduce risk, they nevertheless engage via technical tools with the customer to increase accuracy of the amounts reflected as being in the customer's accounts at any given time, which has the indirect effect of ultimately reducing risk, but also increases the confidence and satisfaction of all system participants.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A distributed payment system comprising:
a first bank at which a user deposit account of a customer is established, the user deposit account being associated with a payment vehicle of the customer to fund transactions initiated via the payment vehicle;
a second bank at which a facilitator account of an issuer of the payment vehicle is established; and
a facilitation agent in communication with a first bank agent of the first bank and a second bank agent of the second bank to issue messages or system triggers associated with money transfers within the distributed payment system,
wherein the facilitation agent establishes a facilitator clearing account to hold unreconciled funds of customers having payment vehicles and deposit accounts at the first bank, and establishes a facilitator servicing account to hold reconciled funds of the customers having payment vehicles and deposit accounts at the first bank, and
wherein the facilitation agent is configured to:
facilitate real time transfer of money into and out of the user deposit account with respect to the facilitator clearing account responsive to the customer initiating a transaction,
facilitate a net transfer of money between the facilitator clearing account and the facilitator servicing account based on summing all transactions in a given period, and
facilitate a transfer of funds between the facilitator servicing account and the facilitator account of the second bank based on the summing of all transactions in the given period.

2. The distributed payment system of claim 1, wherein the transaction is a purchase made with a payment card as the payment vehicle at a merchant for a purchase amount,
wherein immediately responsive to the purchase made, the facilitator issues a hold on the user deposit account and the purchase amount is transferred from the facilitator account to the merchant, and
wherein, responsive to the purchase amount being transferred from the facilitator account to the merchant, the facilitator debits the user deposit account by the purchase amount and credits the purchase amount to the facilitator clearing account.

3. The distributed payment system of claim 1, wherein the transaction is a refund on a prior purchase made with a payment card as the payment vehicle at a merchant for a purchase amount, and the refund is for a refund amount matching the purchase amount,
wherein immediately responsive to the refund amount being returned by the merchant, the facilitator transfers the refund amount to the facilitator account to the merchant, and
wherein, responsive to the refund amount being transferred to the facilitator account to the merchant, a system trigger causes a debit of the facilitator clearing account by the refund amount and the refund amount is credited to the user deposit account.

4. The distributed payment system of claim 1, wherein the transaction is a purchase made with a payment card as the payment vehicle at a merchant for a purchase amount,
wherein immediately responsive to the purchase made, the facilitator transfers the purchase amount from the facilitator account to the merchant, and
wherein, responsive to the purchase amount being transferred from the facilitator account to the merchant, the facilitator debits the user deposit account by the purchase amount and credits the purchase amount to the facilitator clearing account.

5. The distributed payment system of claim 1, wherein the transaction is a payment reversal on a prior purchase made with a payment card as the payment vehicle at a merchant for a purchase amount,
wherein immediately responsive to the payment reversal being initiated, a system trigger causes a debit of the facilitator clearing account by the refund amount and the refund amount is credited to the user deposit account,
wherein a net of all transferred money with respect to the facilitator clearing account in a given time is transferred with respect to the facilitator servicing account at the end of the given time, and
wherein after the given time, the facilitator transfers the net of all transferred money from the facilitator servicing account to a master servicing account of a third bank.

6. The distributed payment system of claim 1, wherein the facilitator further establishes a repayment clearing account and a repayment servicing account at the first bank,
wherein the transaction is a loan payment associated with a loan made with respect to a purchase using the payment vehicle, the loan payment having a payment amount,
wherein immediately responsive to the loan payment, the user deposit account is debited by the payment amount and the payment amount is credited to the repayment clearing account,
wherein the payment amount is debited from the facilitator clearing account and credited to the facilitator servicing account at the end of a given time, and
wherein after the given time, the facilitator transfers the payment amount from the facilitator servicing account to a master servicing account of a third bank to deduct the payment amount from an outstanding loan balance associated with the loan.

7. The distributed payment system of claim 1, further comprising a machine learning module, wherein the machine learning module employs load balancing with respect to system resources for fraud detection.

8. The distributed payment system of claim 1, further comprising a machine learning module, wherein the machine learning module schedules individual fraud monitoring activities.

9. The distributed payment system of claim 1, further comprising a machine learning module, wherein the machine learning module monitors account liquidity information of the user deposit account over time to reduce a risk of overdraft from the user deposit account.

10. The distributed payment system of claim 9, wherein the machine learning module further monitors liquidity information for a plurality of user deposit accounts simultaneously to reduce a risk of overdraft from each of the plurality of user deposit accounts.

11. The distributed payment system of claim 9, wherein the machine learning module reduces the risk of overdraft by scheduling two or more partial transfers less than an amount of the transaction until the amount of the transaction has been transferred at times selected based on a likelihood of funds being available in the user deposit account to support an individual partial transfer at a corresponding time.

12. A method for instantaneous transaction with respect to a user deposit account at a different bank than a card issuer account for a payment vehicle used for transacting, the method comprising:
establishing communication with a first bank agent of a first bank and a second bank agent of a second bank to issue messages or system triggers associated with money transfers within a distributed payment system, the first bank having the user deposit account of a customer established;
establishing a facilitator clearing account to hold unreconciled funds of customers having payment vehicles and deposit accounts at the first bank;
establishing a facilitator servicing account to hold reconciled funds of the customers having payment vehicles and deposit accounts at the first bank;
facilitating real time transfer of money into and out of the user deposit account with respect to the facilitator clearing account responsive to the customer initiating a transaction;
facilitating a net transfer of money between the facilitator clearing account and the facilitator servicing account based on summing all transactions in a given period; and
facilitating a transfer of funds between the facilitator servicing account and a facilitator account of the card issuer at a second bank based on the summing of all transactions in the given period.

13. The method of claim 12, wherein the transaction is a purchase made with a payment card as the payment vehicle at a merchant for a purchase amount, and the method further comprises
immediately responsive to the purchase made, issuing a hold on the user deposit account and the purchase amount is transferred from the facilitator account to the merchant, and
responsive to the purchase amount being transferred from the facilitator account to the merchant, debiting the user deposit account by the purchase amount and crediting the purchase amount to the facilitator clearing account.

14. The method of claim 12, wherein the transaction is a refund on a prior purchase made with a payment card as the payment vehicle at a merchant for a purchase amount, and the refund is for a refund amount matching the purchase amount, and wherein the method further comprises:
immediately responsive to the refund amount being returned by the merchant, transferring the refund amount to the facilitator account to the merchant, and
responsive to the refund amount being transferred to the facilitator account to the merchant, causing a debit of the facilitator clearing account by the refund amount and the refund amount being credited to the user deposit account.

15. The method of claim 12, wherein the transaction is a purchase made with a payment card as the payment vehicle at a merchant for a purchase amount, and wherein the method further comprises:
immediately responsive to the purchase made, transferring the purchase amount from the facilitator account to the merchant, and
responsive to the purchase amount being transferred from the facilitator account to the merchant, debiting the user deposit account by the purchase amount and crediting the purchase amount to the facilitator clearing account.

16. The method of claim 12, wherein the transaction is a payment reversal on a prior purchase made with a payment card as the payment vehicle at a merchant for a purchase amount, and wherein the method further comprises:
immediately responsive to the payment reversal being initiated, causing a debit of the facilitator clearing account by the refund amount and the refund amount is credited to the user deposit account,
wherein a net of all transferred money is with respect to the facilitator clearing account in a given time is transferred with respect to the facilitator servicing account at the end of the given time, and
wherein after the given time, the facilitator transfers the net of all transferred money from the facilitator servicing account to a master servicing account of a third bank.

17. The method of claim 12, wherein a repayment clearing account and a repayment servicing account are established at the first bank,
wherein the transaction is a loan payment associated with a loan made with respect to a purchase using the payment vehicle, the loan payment having a payment amount,
wherein immediately responsive to the loan payment, the user deposit account is debited by the payment amount and the payment amount is credited to the repayment clearing account,
wherein the payment amount is debited from the facilitator clearing account and credited to the facilitator servicing account at the end of a given time, and
wherein after the given time, the facilitator transfers the payment amount from the facilitator servicing account to a master servicing account of a third bank to deduct the payment amount from an outstanding loan balance associated with the loan.

18. The method of claim 12, further comprising a machine learning module employing load balancing with respect to system resources for fraud detection.

19. The method of claim 12, further comprising a machine learning module monitoring account liquidity information of the user deposit account over time to reduce a risk of overdraft from the user deposit account.

20. The method of claim 19, wherein the machine learning module reduces the risk of overdraft by scheduling two or more partial transfers less than an amount of the transaction until the amount of the transaction has been transferred at times selected based on a likelihood of funds being available in the user deposit account to support an individual partial transfer at a corresponding time.
